(19) United States
(12) Patent Application Publication
(10) Pub. No.: US 2009/0216877 A1
(43) Pub. Date: Aug. 27, 2009

(54) Network monitoring system with common storage medium and a method thereof

(76) Inventors: Ming-Jen Hsu, Taipei City (TW); Chia-Cheng Kau, Beigang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,117

(22) Filed: Apr. 28, 2008

(30) Foreign Application Priority Data
Feb. 22, 2008 (TW) 97106384

(51) Int. Cl. G06F 15/173

(52) U.S. Cl. 709/224

(57) ABSTRACT

A network monitoring system with common storage medium includes at least one monitor, a network communication path, a monitoring host, a network memory, and a display screen. The monitoring host assigns a different IP address to each of the monitors. When the network monitoring system is started, the monitoring host controls each of the monitors to obtain the monitor data according to the IP address. Next, the monitoring host uses the data serial stream transmission technology to obtain the monitor data from the monitors via the network communication path. Finally, the monitoring host stores the monitor data and transmits the monitor data to the display screen and display it. Thereby, the resource is shared, and the network monitor is achieved.

### BACKGROUND OF THE INVENTION

1. Field of the Invention

The present invention relates to a network monitoring system with common storage medium and a method thereof. In particular, this invention relates to a network monitoring system and a method thereof that uses a common image storage device to store the monitor data of a plurality of monitoring video recorders and shares the system resources.

2. Description of the Related Art

As information technology has rapidly developed, safety monitoring devices have been digitized and utilize network technology. Due to the safety monitoring devices having been digitized, the data can be easily processed and stored and the devices become more stable and are controllable. Because Internet and wide-band Internet become popular, the monitor data can be transmitted more easily and rapidly. Therefore, the network digital safety monitoring devices is a trend.

Reference is made to FIG. 1, which shows a schematic diagram of a single video recording and monitoring system of the prior art. The single video recording and monitoring system 1 includes a video recorder 10, a monitoring device 12, and a display screen 14. The video recorder 10 has an image detection unit 102, a signal processing and encoding unit 104, and an output port 106. The image detection unit 102 obtains monitor data S1 and transmits the monitor data S1 to the signal processing and encoding unit 104. The signal processing and encoding unit 104 performs a data converting process and an encode process to the monitor data S1 to generate video data S2. The video data S2 is outputted from the output port 106 as a composite video broadcast signal.

Reference is made to FIG. 1 again. The monitoring device 12 includes an input port 120, a video decode and digital encode-output unit 122, and a storage unit 124. The input port 120 is connected with the output port 106 of the video recorder 10 via a transmission line 11 to communicate with the video recorder 10. The monitoring device 12 obtains the video data S2 from the output port 106 of the video recorder 10 via the transmission line 11. The video data S2 is transmitted to the video decode and digital encode-output unit 122. The video decode and digital encode-output unit 122 performs decode process and a digital encode process to the video data S2, and transmits the decoded video data S2 to the display screen 14 and displays it. At the same time, the digital encoded video data S2 is transmitted to the storage unit 124 and is stored.

Reference is made to FIGS. 1 and 2. FIG. 2 is a schematic diagram of a plurality of sets of video recording and monitoring systems of the prior art. The plurality of sets of video recording and monitoring systems 2 is composed of a plurality of single video recording and monitoring systems 1. Therefore, the plurality of sets of video recording and monitoring systems 2 has a plurality of video recorders 10, a plurality of monitoring devices 12, and a plurality of display screens 14. In the plurality of sets of video recording and monitoring systems 2, each of the single video recording and monitoring systems 1 respectively stores the monitor data S1 in the independent storage unit 124. The monitor data S1 cannot be shared to the other single video recording and monitoring systems 1 so that the resource cannot be shared. Furthermore, because the plurality of sets of video recording and monitoring systems 2 has a complex and a plurality of video recorders, the total cost is high, it is difficult to construct the system, and the wire layout is complex.

### SUMMARY OF THE INVENTION

One particular aspect of the present invention is to provide a network monitoring system with common storage medium and a method thereof. The plurality of monitoring video recorders of the present invention can share a common monitoring image storage device, such as a hard disk or a memory card etc, via a network system (such as WLAN, LAN, power line, or PoE etc,) in an automatic addressed IP video-recording mode. It does not need the complex video-recording system. The digital video recorder is simplified and the system resource is shared.

The network monitoring system with common storage medium includes at least one monitor, a network communication path, a monitoring host, a network memory, and a display screen. Each of the monitors has an IP address, an image-obtaining unit, an image-compressing unit and a first network interface unit. The image-obtaining unit is used for obtaining monitor data. The image-compressing unit is connected with the image-obtaining unit and the first network interface unit for receiving the monitor data and performing a data converting process and a compressing process to the monitor data, and outputting a compressed monitor data.

The monitoring host includes a second network interface and an image-decompressing and analog output encoding unit. The second network interface is connected to each of the first network interface units via the network communication path. The image-decompressing and analog output encoding unit is connected with the second network interface and the display screen, receives monitor data via the second network interface, the network communication path and each of the first network interface units, performs a data converting process and a decompressing process to the compressed monitor data, and recovers the monitor data for each of the monitor. The display screen receives and displays the monitor data.

Furthermore, the network memory is connected with the second network interface, and stores the compressed monitor data via the second network interface, the network communication path and the each of the first network interface units.

The network monitoring method with a common storage medium of the present invention is applied to a network monitoring system. The network monitoring system includes at least one monitor and a monitoring host. The network monitoring method includes the following steps. First, the monitoring host assigns a different IP address for each of the monitors, and controls each of the monitors to obtain the monitor data and compress the monitor data. Next, the monitoring host uses the data serial stream transmission technology to receive the compressed monitor data from each of the monitors according to the different IP address for each of the monitors. Finally, the monitoring host stores the compressed monitor data, or the monitoring host performs a decompressing process to the compressed monitor data to recover the monitor data, and transmits the monitor data to a display screen and displays the monitor data.

The network monitoring system with common storage medium and a method thereof utilizes the automatic addressed IP video-recording mode and uses the data serial stream transmission technology to obtain the monitor data from a plurality of monitors via the network system, and stores the monitor data from a plurality of monitors in a common storage device to share the system resource. Moreover, the present invention uses a single monitoring host to process the monitor data from a plurality of monitors. It does not need the complex video recorder, and the digital video recorder is simplified.

For further understanding of the invention, reference is made to the following detailed description illustrating the embodiments and examples of the invention. The description is for illustrative purpose only and is not intended to limit the scope of the claim.

### BRIEF DESCRIPTION OF THE DRAWINGS

The drawings included herein provide a further understanding of the invention. A brief introduction of the drawings is as follows:

FIG. 1 is a schematic diagram of a single video recording and monitoring system of the prior art;

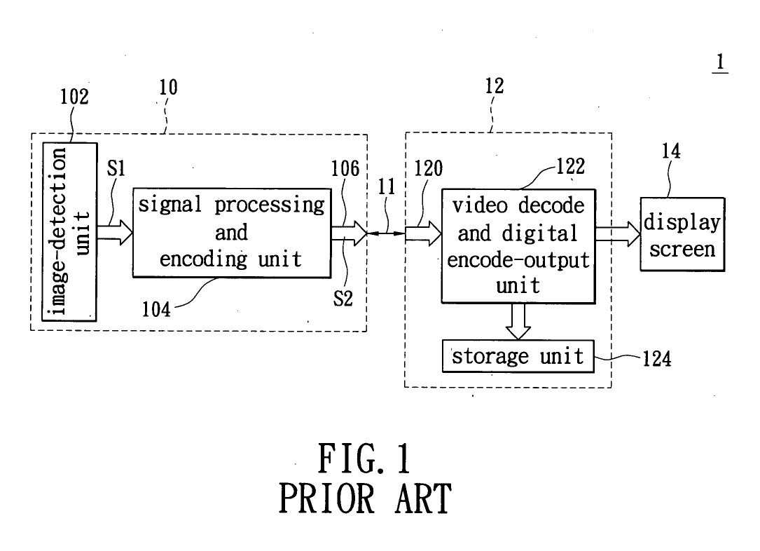

FIG. 2 is a schematic diagram of a plurality of sets of video recording and monitoring systems of the prior art;

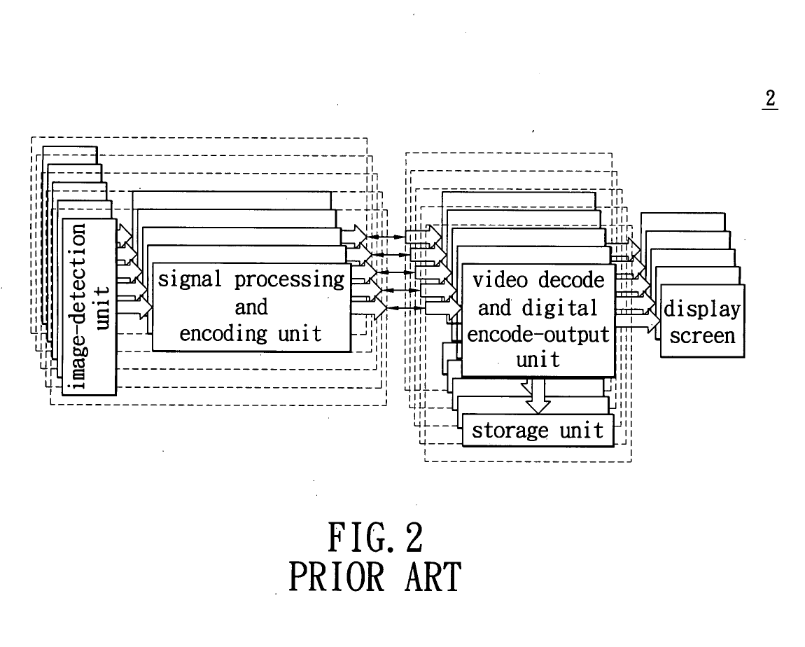

FIG. 3 is a schematic diagram of a single set of network monitoring system of the first embodiment of the present invention;

FIG. 4 is a schematic diagram of a plurality of sets of network monitoring system of the second embodiment of the present invention; and

FIG. 5 is a flow chart of the network monitoring method with a common storage medium of the present invention.

### DETAILED DESCRIPTION OF THE PREFERRED EMBODIMENTS

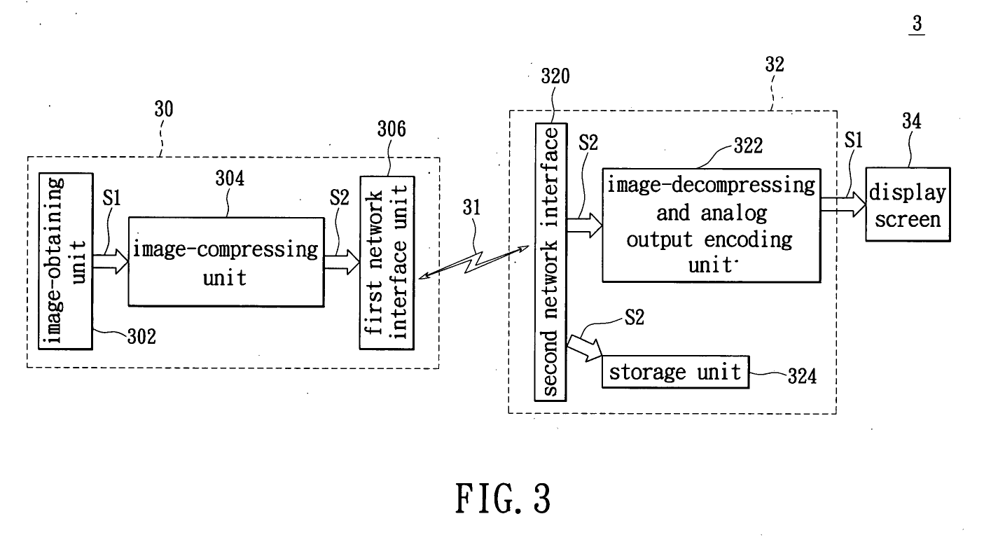

Reference is made to FIG. 3, which shows a schematic diagram of a single set of network monitoring system of the first embodiment of the present invention. The single set of network monitoring system 3 includes a monitor 30, a network communication path 31, a monitoring host 32 and a display screen 34. The monitor 30 communicates with the monitoring host 32 that is connected with the network communication path 31 and located at a remote location via the network communication path 31. The network communication path 31 can be WLAN, LAN, power line, or PoE.

The monitor 30 is composed of an image-obtaining unit 302, an image-compressing unit 304 and a first network interface unit 306. The first network interface unit 306 of the monitor 30 is connected with the network communication path 31, and communicates with the monitoring host 32 via the network communication path 31. The image-obtaining unit 302 of the monitor 30 obtains monitor data S1 and transmits the monitor data S1 to the image-compressing unit 304 connected with the image-obtaining unit 302. After the image-compressing unit 304 of the monitor 30 receives the monitor data S1, the image-compressing unit 304 performs a data converting process to the monitor data to convert the analog monitor data S1 into digital monitor data S1. Next, the image-compressing unit 304 performs a compressing process the digital monitor data S1 to generate a compressed monitor data S2. The compressed monitor data S2 is transmitted to the monitoring host 32 that is connected with the network communication path 31 and located at a remote location via the network communication path 31.

Reference is made to FIG. 3 again. The monitoring host 32 is composed of a second network interface 320, a storage unit 324, and an image-decompressing and analog output encoding unit 322. The second network interface 320 of the monitoring host 32 is connected with the network communication path 31 and communicates with the monitor 30 via the network communication path 31. The storage unit 324 of the monitoring host 32 is connected with the second network interface 320 to access the compressed monitor data S2 outputted from the monitor 30 via the second network interface 320, the network communication path 31 and the first network interface unit 30 and store the compressed monitor data S2. The storage unit 324 can be a hard disk or a memory card.

The image-decompressing and analog output encoding unit 322 of the monitoring host 32 is connected with the second network interface 320, and receives the compressed monitor data S2 outputted from the monitor 30 via the second network interface 320, the network communication path 31 and the first network interface unit 306. After the image-decompressing and analog output encoding unit 322 receives the compressed monitor data S2, the image-decompressing and analog output encoding unit 322 decompresses the compressed monitor data S2 to recover to a digital monitor data S1. Next, the image-decompressing and analog output encoding unit 322 converts the digital monitor data S1 into the analog monitor data S1. The analog monitor data S1 is transmitted to the monitor 34 connected with the image-decompressing and analog output encoding unit 322, and is displayed on the display screen 34.

Reference is made to FIG. 3 again. In the single set of network monitoring system 3, the monitoring host 32 assigns an IP address to the monitor 30, and the IP address is stored in the storage unit 324. When the single set of network monitoring system 3 is started, the monitoring host 32 finds the monitor 30 according to the IP address and controls the monitor 30 to obtain the monitor data S1. Next, the monitoring host 32 uses the data serial stream transmission technology to obtain the monitor data S1 via the network communication path 31. Finally, the monitoring host 32 stores the monitoring data S1 in the storage unit 324 and transmits the monitor data S1 to the display screen 34 to display. Thereby, the monitor data Si can be stored and monitored.

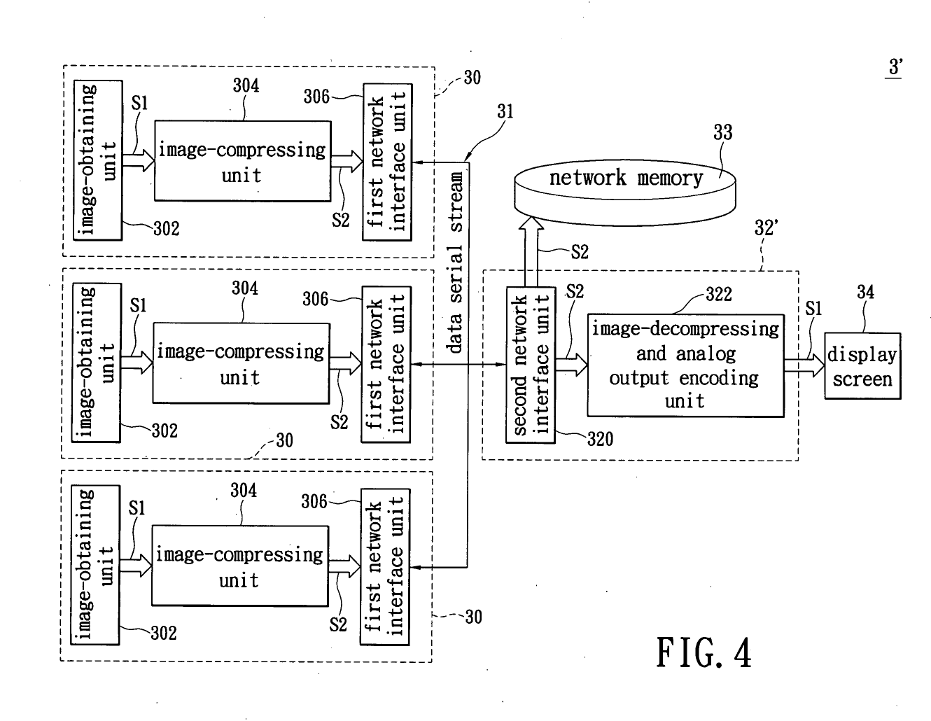

Reference is made to FIG. 4, which shows a schematic diagram of a plurality of sets of network monitoring system of the second embodiment of the present invention. The plurality of sets of network monitoring system 3′ includes a plurality of monitors 30, a network communication path 31, a monitoring host 32′, a network memory 33 and a display screen 34. Each of the monitors 30 communicates with the monitoring host 32′ that is connected with the network communication path 31 and located at a remote location via the network communication path 31. The network communication path 31 can be WLAN, LAN, power line, or PoE.

Each of the monitors 30 is composed of an image-obtaining unit 302, an image-compressing unit 304 and a first network interface unit 306. The first network interface unit 306 of each of the monitors 30 is connected with the network communication path 31, and communicates with the monitoring host 32′ that is connected with the network communication path 31 and located at a remote location via the network communication path 31. The image-obtaining unit 302 of each of the monitors 30 obtains its monitor data S1 and transmits the monitor data S1 to the image-compressing unit 304 of each of the monitors 30. After the image-compressing unit 304 of each of the monitors 30 receives the monitor data S1, the image-compressing unit 304 performs a data converting process to the monitor data S1 to convert the analog monitor data S1 into digital monitor data S1. Next, the image-compressing unit 304 performs a compressing process the digital monitor data S1 to generate a compressed monitor data S2. The compressed monitor data S2 is transmitted to the monitoring host 32′ that is connected with the network communication path 31 and located at a remote location via the network communication path 31.

Reference is made to FIG. 4 again. The monitoring host 32′ is composed of a second network interface 320 and an image-decompressing and analog output encoding unit 322. The second network interface 320 of the monitoring host 32′ is connected with the network communication path 31 and communicates with the monitor 30 via the network communication path 31.

The image-decompressing and analog output encoding unit 322 of the monitoring host 32′ is connected with the second network interface 320, and receives the compressed monitor data S2 outputted from the monitor 30 via the second network interface 320, the network communication path 31 and the first network interface unit 306. After the image-decompressing and analog output encoding unit 322 uses the data serial stream transmission technology to obtain the compressed monitor data S2 outputted from each of the monitors 30, the image-decompressing and analog output encoding unit 322 decompresses the compressed monitor data S2 to recover the compressed monitor data S2 into a digital monitor data S1. Next, the image-decompressing and analog output encoding unit 322 converts the digital monitor data S1 into the analog monitor data S1. The analog monitor data S1 is transmitted to the monitor 34 connected with the image-decompressing and analog output encoding unit 322, and is displayed on the display screen 34.

Furthermore, the network memory 33 is connected with the second network interface 320 of the monitoring host 32′ to access the compressed monitor data S2 outputted from the monitor 30 via the second network interface 320, the network communication path 31 and the first network interface unit 30 and store the compressed monitor data S2. The network memory 33 can be a hard disk or a memory card.

Reference is made to FIG. 4 again. In the plurality of sets of network monitoring system 3′, the monitoring host 32′ assigns a different IP address to each of the monitors 30, and the different IP address is stored in the storage unit 324. When the plurality of sets of network monitoring system 3′ is started, the monitoring host 32′ finds the corresponding monitor 30 according to the IP address and controls the monitor 30 to obtain the monitor data S1. Next, the monitoring host 32′ uses the data serial stream transmission technology to obtain the monitor data S1 of each of the monitors 30 via the network communication path 31. Finally, the monitoring host 32′ stores the monitoring data S1 and transmits the monitor data S1 to the display screen 34 to display. Thereby, the monitor data S1 of each of the monitors 30 can be stored and monitored.

The network monitoring system with common storage medium uses the monitoring host 32′ to automatically assign an addressed IP to each of the monitors 30, uses the data serial stream transmission technology to obtain the monitor data from each of the monitors 30 via the network system, and stores the monitor data of each of the monitors 30 in a common network memory 33 to share the system resource. Moreover, the present invention uses a single monitoring host 32′ to process the monitor data from a plurality of monitors. It does not need the complex video recorder, and the digital video recorder is simplified.

The flowing is used for illustrating the network monitoring method with a common storage medium. Reference is made to FIG. 4, which shows the flow chart of the network monitoring method with a common storage medium of the present invention.

The network monitoring method with a common storage medium of the present invention is applied to a network monitoring system 3′. The network monitoring system 3′ includes a plurality of monitors 30 and a monitoring host 32′. The network monitoring method includes the following steps. First, the monitors 30 communicate with the monitoring host 32′ via a network communication path 31. The network communication path 31 can be WLAN, LAN, power line, or PoE. Next, the monitoring host 32′ assigns a different IP address for each of the monitors 30 (S10). The monitoring host 32′ controls each of the monitors 30 according to its IP address to obtain the monitor data S1 and compress the monitor data S1 (S12). Next, after the monitoring host 32′ obtains the monitor data S1 and compresses the monitor data S1, the monitoring host 32′ uses the data serial stream transmission technology to receive the compressed monitor data S2 from each of the monitors 30 according to the different IP address for each of the monitors 30 (S14). Finally, the monitoring host 32′ stores the compressed monitor data S2 in a network memory 33 (S16).

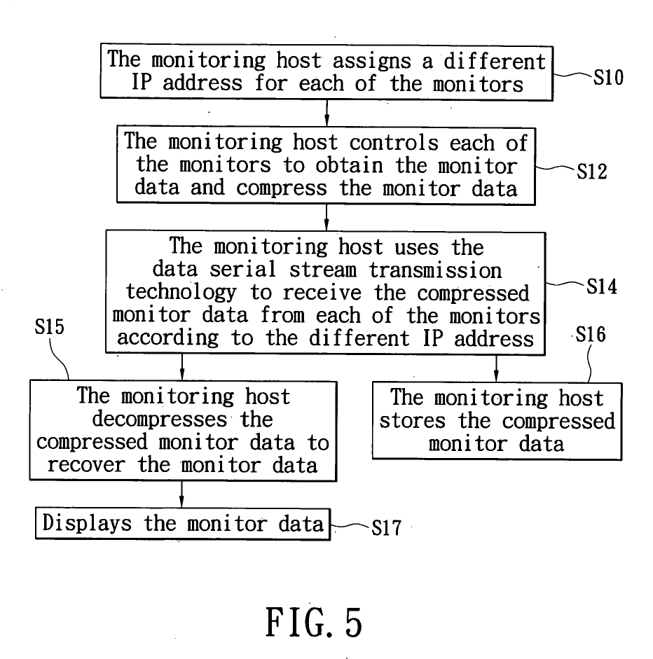

Reference is made to FIGS. 4 and 5. After step S14, the monitoring host 32′ also performs a decompressing process to the compressed monitor data S2 to recover the monitor data S1 (S15). Next, the monitoring host 32′ transmits the recovered monitor data S2 to a display screen 34 and displays the monitor data (S17).

The network monitoring method with a common storage medium uses the monitoring host 32′ to automatically assign an addressed IP to each of the monitors 30, uses the data serial stream transmission technology to obtain the monitor data from each of the monitors 30 via the network system, and stores the monitor data of each of the monitors 30 in a common network memory 33 to share the system resource. Moreover, the present invention uses a single monitoring host 32′ to process the monitor data from a plurality of monitors. It does not need the complex video recorder, and the digital video recorder is simplified.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A network monitoring system with common storage medium, comprising:
at least one monitor having an IP address, wherein the monitor comprises:
an image-obtaining unit for obtaining monitor data;
an image-compressing unit connected with the image-obtaining unit,
wherein the image-compressing unit receives the monitor data and performs a data converting process and a compressing process to the monitor data, and outputs a compressed monitor data; and
a first network interface unit connected with the image-compressing unit;
a network communication path;
a monitoring host, comprising:
a second network interface connected to the first network interface unit of each of the monitor via the network communication path; and
an image-decompressing and analog output encoding unit connected with the second network interface, wherein image-decompressing and analog output encoding unit receives monitor data via the second network interface,
the network communication path and each of the first network interface units, performs a data converting process and a decompressing process to the compressed monitor data, and recovers the monitor data for each of the monitors;
a network memory connected with the second network interface, wherein the network memory accesses the compressed monitor data via the second network interface, the network communication path and each of the first network interface units; and
a display screen connected with the image-decompressing and analog output encoding unit, wherein the display screen receives the monitor data and displays the monitor data.

2. The network monitoring system with common storage medium as claimed in claim 1, wherein the network communication path is WLAN, LAN, power line, or PoE.

3. The network monitoring system with common storage medium as claimed in claim 1, wherein the network memory is a hard disk or a memory card.

4. The network monitoring system with common storage medium as claimed in claim 1, wherein each of the monitors uses the data serial stream transmission technology to transmit the compressed monitor data to the monitoring host.

5. A network monitoring method with a common storage medium, applied to a network monitoring system, wherein the network monitoring system includes at least one monitor and a monitoring host, the network monitoring method comprising:
a. assigning a different IP address for each of the monitors by the monitoring host;
b. controlling each of the monitors to obtain monitor data and compress the monitor data by the monitoring host;
c. using the data serial stream transmission technology to receive the compressed monitor data from each of the monitors according to the different IP address of each of the monitors by the monitoring host; and
d. storing the compressed monitor data by the monitoring host.

6. The network monitoring method with a common storage medium as claimed in claim 5, wherein the monitoring host individually receives the compressed monitor data via a network communication path in step c.

7. The network monitoring method with a common storage medium as claimed in claim 6, wherein the network communication path is WLAN, LAN, power line, or PoE.

8. The network monitoring method with a common storage medium as claimed in claim 5, wherein the monitoring host stores the compressed monitor data in a network memory in step d.

9. The network monitoring method with a common storage medium as claimed in claim 8, wherein the network memory is a hard disk or a memory card.

10. The network monitoring method with a common storage medium as claimed in claim 5, further comprising a step e of decompressing the compressed monitor data by the monitoring host to recover the monitor data after step c.

11. The network monitoring method with a common storage medium as claimed in claim 10, further comprising a step f of displaying the monitor data after the step e.

12. The network monitoring method with a common storage medium as claimed in claim 11, wherein the monitoring host transmits the monitor data to a display screen for displaying the monitor data in step f.

13. A network monitoring system with common storage medium, comprising:
a monitor having an IP address, wherein the monitor comprises:
an image-obtaining unit for obtaining monitor data;
an image-compressing unit connected with the image-obtaining unit,
wherein the image-compressing unit receives the monitor data and performs a data converting process and a compressing process to the monitor data, and
outputs a compressed monitor data; and
a first network interface unit connected with the image-compressing unit;
a network communication path;
a monitoring host, comprising:
a second network interface connected to the first network interface unit of the monitor via the network communication path; and
an image-decompressing and analog output encoding unit connected with the second network interface, wherein image-decompressing and analog output encoding unit receives monitor data via the second network interface,
the network communication path and the first network interface unit,
performs a data converting process and a decompressing process to the compressed monitor data, and recovers the monitor data for the monitor;
a storage unit connected with the second network interface, wherein the storage unit accesses the compressed monitor data via the second network interface, the network communication path and the first network interface unit; and
a display screen connected with the image-decompressing and analog output encoding unit, wherein the display screen receives the monitor data and displays the monitor data.

14. The network monitoring system with common storage medium as claimed in claim 13, wherein the network communication path is WLAN, LAN, power line, or PoE.

15. The network monitoring system with common storage medium as claimed in claim 13, wherein the network memory is a hard disk or a memory card.

16. The network monitoring system with common storage medium as claimed in claim 13, wherein each of the monitors uses the data serial stream transmission technology to transmit the compressed monitor data to the monitoring host.
